(19) United States
(12) Patent Application Publication
(10) Pub. No.: US 2010/0074282 A1
(43) Pub. Date: Mar. 25, 2010

(54) WAVELENGTH-TUNABLE EXTERNAL CAVITY LASER

(75) Inventors: Su-Hwan Oh, Seo-gu (KR); Ki-Soo Kim, Yuseong-gu (KR); Dae-Kon Oh, Yuseong-gu (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/501,916

(22) Filed: Jul. 13, 2009

(30) Foreign Application Priority Data
Sep. 23, 2008 (KR) 10-2008-0093260

(51) Int. Cl. H01S 3/10

(52) U.S. Cl. 372/20

(57) ABSTRACT

Provided is a tunable external cavity laser. The tunable external cavity laser includes that a bragg grating hermetically packaged in a TO can, a superluminescent diode (SLD) using an optical source signal and an optical fiber. A lasing wavelength is decided when the optical source signal emitted from the SLD is reflected by the bragg grating and the lasing wavelength is output to the optical fiber through the SLD.

### CROSS-REFERENCE TO RELATED APPLICATIONS

This U.S. non-provisional patent application claims priority under 35 U.S.C. § 119 of Korean Patent Application No. 10-2008-0093260, filed on Oct. 23, 2008, the entire contents of which are hereby incorporated by reference.

### BACKGROUND

The present invention disclosed herein relates to a wavelength-tunable external cavity laser, and more particularly, to a wavelength-tunable external cavity laser having high optical power.

The signals of the different wavelength can be transmitted through an optical fiber without the wavelength interference of its This transmission method is called “wavelength division multiplexing (WDM).” The data transmission rate of an optical fiber can be significantly increased by using WDM.

A stable and low-cost optical source is required to construct a cost-effective wavelength division multiplexing-passive optical network (WDM-PON) optical network. There are three representative types of WDM-PON optical sources. One is the method of a wavelength-locked (WL) Fabry Perot laser diode (FP-LD). The transmission characteristics are degraded by mode division noise when an FP-LD is used as an optical source of a WDM-PON optical access network. Thus, they has been developed to reduce the mode division noise by improving structure of this system, which operated for 1.25-Gbps data transmission. Another WDM-PON optical source is one that employs a re-modulation scheme based on a reflective semiconductor optical amplifier (RSOA), and many researcher has been reported on RSOAs for loop-back WDM-PONs (in which downstream optical signals are directly re-modulated and used). The third type of WDM-PON optical source is a-tunable optical source based on a planar lightwave circuit-external cavity laser (PLC-ECL). The performance of the WL FP-LD and the RSOA are largely dependent on optical source characteristics, and data-light in the direct modulation is limited to 1.25-Gbps. In this point, the tunable laser is an attractive solution for the WDM-PON due to cost-effective and operation characteristics of over 2.5 Gb/s. For this purpose, it has been studied on the tunable lasers based on PLC with good mass-production characteristics.

### SUMMARY

The present invention provides a tunable external cavity laser to reduce the loss of optical power.

Embodiments of the present invention provide tunable external cavity lasers including: a bragg grating hermetically packaged in a TO can, a superluminescent diode (SLD) using an optical source signal and an optical fiber, wherein a lasing wavelength is decided when the optical source signal emitted from the SLD is reflected by the bragg grating and the lasing wavelength is output to the optical fiber through the SLD.

In some embodiments, the TO can is coupled to a rear facet of the SLD, and the optical fiber is coupled to a front facet of the SLD, and the optical wavelength reflected by the bragg grating is re-reflected at the front facet of the SLD which is made the cavity for resonance and is output to the optical fiber through the front facet of SLD.

In other embodiments, the bragg grating may be formed in a planar lightwave circuit platform.

In still other embodiments, the planar lightwave circuit platform may include: an lower cladding layer on a silica substrate; an upper cladding layer on the lower cladding layer; and a first waveguide between the lower cladding layer and the upper cladding layer, wherein the bragg grating may be formed at the first waveguide.

In even other embodiments, the planar lightwave circuit platform may further include a first thermoelectric cooler platform under a bottom surface of the silica substrate.

In yet other embodiments, the upper cladding layer may include a bragg electrode configured to vary temperature of the bragg grating for adjusting an operational wavelength of the bragg grating.

In further embodiments, the SLD may include: an activation layer formed on substrate; and a second waveguide formed at the activation layer for transmitting an optical source signal reflected from the bragg grating to the optical fiber.

In still further embodiments, the SLD may further include a thermoelectric cooler platform under a bottom surface of the substrate of SLD.

In even further embodiments, the first and second waveguides be coupled to each other by an active alignment method.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a schematic view illustrating tunable external cavity laser according to an embodiment of the present invention; and

FIG. 2 is a schematic view illustrating a planar lightwave circuit structure according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions are exaggerated for clarity of illustration. Like reference numerals refer to like elements throughout.

It will be understood that although the terms first and second are used herein to describe various elements such as waveguides, these elements should not be limited by these terms. These terms are only used to distinguish one element from another element.

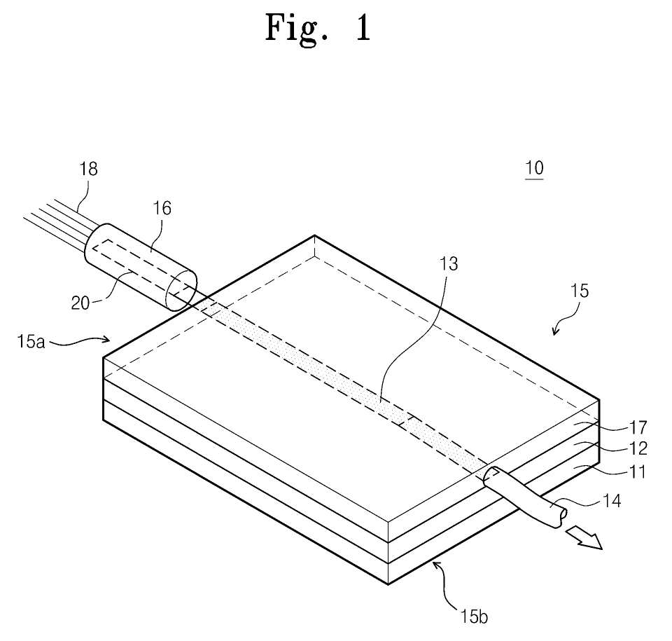

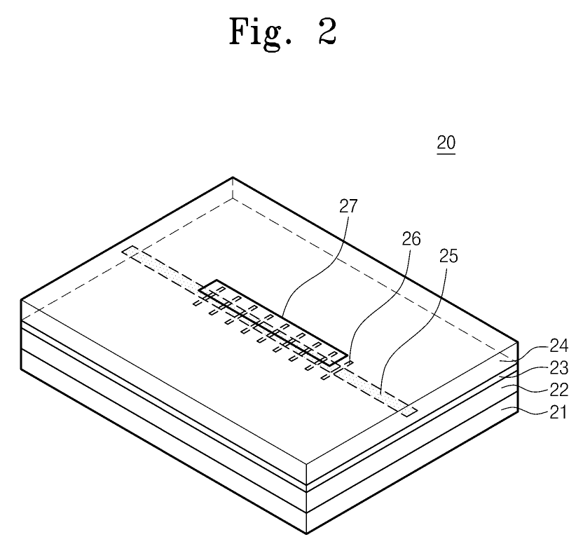

With reference to FIGS. 1 and 2, a tunable external cavity laser 10 will now be described according to exemplary embodiments of the present invention. The wavelength-tunable external cavity laser 10 includes a TO can 16 having a Bragg grating 26, and a superluminescent diode (SLD) 15 coupled to the TO can 16 for outputting an optical source signal to an optical fiber 14. The Bragg grating 26 is formed at a planar lightwave circuit platform 20. The TO can 16 and the optical fiber 14 may be coupled to rear facet 15a and rear facet 15b of the SLD 15, respectively. The rear facet 15a and front facet 15b may be opposite to each other.

The planar lightwave circuit platform 20 includes an lower cladding layer 23 formed on a silica substrate 22, an upper cladding layer 24 formed on the lower cladding layer 23, and a first waveguide 25 formed between the lower cladding layer 23 and the upper cladding layer 24. The Bragg grating 26 is formed at the first waveguide 25. The Bragg grating 26 may be formed upper silica or polymer waveguide

The planar lightwave circuit platform 20 may further include a first thermoelectric cooler 21 attached to the bottom surface of the silica substrate 22. The temperature of the first thermoelectric cooler 21 can be changed according to the direction of a current by the thermoelectric effect. Therefore, the temperature of the planar lightwave circuit platform 20 can be controlled using the first thermoelectric cooler 21. The upper cladding layer 24 may include a Bragg electrode 27 configured to change the temperature of the Bragg grating 26 for varying the operational frequency of the Bragg grating 26. The Bragg electrode 27 may function as a heater. A TO can electrode 18 is connected to a side of the TO can 16. The TO can electrode 18 may be connected to the planar lightwave circuit platform 20. For example, the TO can electrode 18 may be connected to the Bragg electrode 27 and the first thermoelectric cooler 21.

The SLD 15 is an optical device having the high optical power, the wide optical bandwidth, and the low spectral modulation. Like the case of a laser diode, the SLD 15 has high optical power owing to light amplification by stimulated emission; however, unlike the laser diode, the SLD 15 is configured to reduce optical resonance so that the SLD 15 can have wide optical bandwidth. Therefore, the SLD 15 has optical power greater than that of a light emitting diode (LED) and an optical bandwidth wider than that of a laser diode.

In detail, the SLD 15 includes an activation layer 17 formed on a substrate 12, and a second waveguide 13 formed at the activation layer 17 to transmit an optical signal reflected from the Bragg grating 26 to the optical fiber 14. The SLD 15 may further include a second thermoelectric cooler 11 attached to the bottom surface of the substrate 12 of SLD 15. The temperature of the second thermoelectric cooler 11 can be changed according to the direction of a current by the thermoelectric effect. The second thermoelectric cooler 11 prevents a temperature increase of the SLD 15 so that the optical power of the SLD 15 can be maintained at a high level.

If a current is applied to the activation layer 17, electrons of the activation layer 17 are excited, and thus light can be emitted from the activation layer 17. In detail, light is emitted while the excited electrons transit to a low energy level and re-couple with holes (simultaneous emission and stimulated emission). The second waveguide 13 may have a stripe shape, and light emitted from the activation layer 17 propagates along the second waveguide 13 with predetermined spatial distribution (mode) and is amplified by the current applied to the activation layer 17. Optical resonance can be reduced by forming the second waveguide 13 in a curved or bent shape, coating an antireflection layer on a side of the second waveguide 13, or forming an absorption region at a side of the second waveguide 13.

The tunable external cavity laser 10 operates as follows. The rear facet 15a of the SLD 15 is antireflection-coated, and thus light generated at the activation layer 17 is incident onto the Bragg grating 26 of the TO can 16 through the rear facet 15a of the SLD 15. The Bragg grating 26 has reflectance greater than that of the front facet 15b of the SLD 15, such that oscillation occurs at the front facet 15b of the SLD 15 by external resonance. Optical loss through the Bragg grating 26 can be reduced in proportion to the reflectance of the Bragg grating 26. The Bragg grating 26 reflects a particular wavelength in accordance with Bragg's law. The particular wavelength can be determined by the grating period of the Bragg grating 26.

The effective reflectance of the Bragg grating 26 can be varied by varying the temperature of the Bragg grating 26 in a way of adjusting a current applied to the Bragg electrode 27, and in this way, the particular wavelength that can be reflected by the Bragg grating 26 can be varied by varying the effective reflectance of the Bragg grating 26. The variation of the particular wavelength is proportional to the variation of the effective reflectance of the Bragg grating 26. If the first waveguide 25 is a polymer waveguide, the particular wavelength may be varied by more than 30 nm. The Bragg grating 26 reflects light having a particular wavelength to the optical fiber 14 through the SLD 15. Therefore, wavelength division multiplexing (WDM) is possible for transmitting signals having different wavelengths through the optical fiber 14.

The first waveguide 25 and the second waveguide 13 may be coupled to each other by an active alignment method. The first waveguide 25 and the second waveguide 13 can be adjusted by the active alignment method so that more light generated at the activation layer 17 can be transmitted from the first waveguide 25 to the second waveguide 13. That is, the coupling efficiency between the first waveguide 25 and the second waveguide 13 can be largely improved. According to the active alignment method, the first waveguide 25 and the second waveguide 13 may be aligned by fixing a point where light intensity is highest by using laser welding.

Unlike the structure shown in FIG. 1, if light emitted from a SLD is directly transmitted to an optical fiber through a Bragg grating, optical loss increases at the Bragg grating and a waveguide where the Bragg grating is disposed. However, in the current embodiment of the present invention, light emitted from the SLD 15 is reflected by the Bragg grating 26 and then transmitted to the optical fiber 14 through the SLD 15. Owing to this structure, optical loss can be reduced when optical signals are output from the SLD 15 to the optical fiber 14. Furthermore, since the first waveguide 25 and the second waveguide 13 are arranged by an active alignment method, coupling loss can also be reduced. Therefore, the wavelength-tunable external cavity laser 10 of the current embodiment can have high optical power. Thus, modulation at about 1.25-Gbps or higher levels is possible by using the wavelength-tunable external cavity laser 10 having high optical power.

According to the embodiments of the present invention, light emitted from the superluminescent diode is reflected by the Bragg grating and is output to the optical fiber through the superluminescent diode. Owing to this structure, optical loss can reduced while light is transmitted from the superluminescent diode to the optical fiber. In addition, since the waveguides are aligned by an active alignment method, the coupling loss between the waveguides can be reduced. According to the embodiments of the present invention, the wavelength-tunable external cavity laser has high optical power. Owing to its high optical power, the tunable external cavity laser can have 1.25-Gbps or higher modulation characteristics.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A tunable external cavity laser comprising:
a bragg grating hermetically packaged in a TO can;
a superluminescent diode (SLD) using an optical source signal; and
an optical fiber,
wherein a lasing wavelength is decided when the optical source signal emitted from the SLD is reflected by the bragg grating and the lasing wavelength is output to the optical fiber through the SLD.

2. The tunable external cavity laser of claim 1, wherein the TO can is coupled to a rear facet of the SLD, and the optical fiber is coupled to a front facet of the SLD, and
the optical wavelength reflected by the bragg grating is re-reflected at the front facet of the SLD which is made the cavity for resonance and is output to the optical fiber through the front facet of SLD.

3. The tunable external cavity laser of claim 1, wherein the bragg grating is formed in planar lightwave circuit platform.

4. The tunable external cavity laser of claim 3, wherein the planar lightwave circuit platform comprises:
an lower cladding layer on a silica substrate;
an upper cladding layer on the lower cladding layer; and
a first waveguide between the lower cladding layer and the upper cladding layer,
wherein the bragg grating is formed at the first waveguide.

5. The tunable external cavity laser of claim 4, wherein the planar lightwave circuit platform further comprises a first thermoelectric cooler under a bottom surface of the silica substrate.

6. The tunable external cavity laser of claim 4, wherein the upper cladding layer comprises a bragg electrode configured to vary temperature of the bragg grating for adjusting an operational wavelength of the bragg grating.

7. The tunable external cavity laser of claim 4, wherein the superluminescent diode comprises:
an activation layer formed on a substrate; and
a second waveguide formed in the activation layer for transmitting an optical source signal reflected from the Bragg grating to the optical fiber.

8. The tunable external cavity laser of claim 7, wherein the SLD further comprises a thermoelectric cooler platform under a bottom surface of the substrate.

9. The tunable external cavity laser of claim 7, wherein the second waveguide of the SLD is coupled to the first waveguide of the bragg grating by an active alignment method.
